(19) United States
(12) Patent Application Publication
(10) Pub. No.: US 2007/0211629 A1
(43) Pub. Date: Sep. 13, 2007

(54) Method and system for controlling wireless LAN route, apparatus for managing wireless LAN, and wireless LAN access terminal

(75) Inventor: Atsuko Mori, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/489,504

(22) Filed: Jul. 20, 2006

(30) Foreign Application Priority Data
Mar. 10, 2006 (JP) 2006-065912

(51) Int. Cl. H04L 12/26

(52) U.S. Cl. 370/230

(57) ABSTRACT

An AP managing server manages wireless LAN apparatuses wirelessly connected to an access terminal. The wireless LAN apparatuses are provided for each communication service (VoIP communication, HTTP communication) in a single subnet and a route connecting to the access terminal is made redundant for each communication service. The AP managing apparatus controls a route to wirelessly connect the access terminal to a wireless LAN apparatuses that supports the communication service requested by the access terminal.

### CROSS-REFERENCE TO RELATED APPLICATIONS

This application is based upon and claims the benefit of priority from the prior Japanese Patent Application No. 2006-065912, filed on Mar. 10, 2006, the entire contents of which are incorporated herein by reference.

### BACKGROUND OF THE INVENTION

1. Field of the Invention

The present invention relates to a technology of a wireless local area network (LAN).

2. Description of the Related Art

In recent years, as more communication infrastructures are built based on an internet protocol (IP), IP communication services are becoming common. With the prevalence of portable phones and personal computers (PC) equipped with a wireless function, on-premises wireless LAN communication within a company or public wireless LAN services as hotspots are provided at inexpensive rates. Based on this situation, accesses using wireless LANs are expected to grow with a demand for various services such as transmission/reception of electronic mail and voice over Internet protocol (VoIP) communication, besides the Internet connection.

In conventional wireless LAN communication, a wireless LAN access terminal, such as a PC, has an ability to detect a plurality of wireless LAN apparatuses (access points (AP)) and the wireless LAN access terminal automatically determines a wireless LAN apparatus having strong LAN radio intensity as an access destination and executes IP communication. When the intensity of a radio wave between the wire LAN access terminal and a wireless LAN apparatus becomes weak due to a change of location of the wireless LAN access terminal, the terminal automatically detects an optimal wireless LAN apparatus. Handover is executed when the apparatus and the terminal are in the same subnet. Re-connection is executed when the apparatus and the terminal are respectively in a different subnet from each other. Thus, communication is continued. Timing at which the handover or the re-connection is determined by the wireless LAN access terminal based on the radio wave intensity (for example, Japanese Patent Application Laid-Open Publication No. 2003-338829 and Japanese Patent Application Publication No. 3529621).

Although access authentication using a RADIUS server, etc., is executed for an access to an IP network through a wireless LAN, a control to limit the number of accesses to a wireless LAN apparatus, etc., is not executed. Therefore, concentration of accesses to a specific wireless LAN apparatus occurs, or degradation of the communication quality and delay of the communication processing are caused on other wireless LAN access terminals (other users), if, for example, downloading of files having large amount of data is executed.

As a measure against the above problem, it is considered to provide a wireless LAN apparatus controller that controls a load of a wireless LAN apparatus. However, only controlling a band used by the wireless LAN apparatus is not enough to prevent excessive load on the wireless LAN apparatus.

In the IP networks, various services are already provided. In the wireless LANs, these services are not yet supported satisfactorily. The services currently provided includes a file transfer protocol (FTP) and the VoIP, besides a hyper text transfer protocol (HTTP). If a single wireless LAN apparatus accepts various services, for example, when a user downloads a large file, the communication quality of VoIP communication being executed by another user can be degraded. Moreover, a measure should be taken against the delay of communication processing caused when accesses from wireless LAN access terminals are concentrated on a single wireless LAN apparatus.

### SUMMARY OF THE INVENTION

It is an object of the present invention to at least solve the above problems in the conventional technologies.

A route control system according to one aspect of the present invention is used in a wireless local area network (LAN) in which a managing apparatus manages a LAN apparatus to which terminals are wirelessly connected. The LAN apparatus is arranged in plurality in a single subnet, according to types of services to be provided to the terminals such that a wireless connection route to the terminals is redundant for each of the types, and the managing apparatus is configured to wirelessly connect the terminal to a LAN apparatus corresponding to a type of service requested by the terminal.

A managing apparatus according to another aspect of the present invention controls wireless connection routes between LAN apparatuses and a terminal. The LAN apparatuses are arranged in plurality in a single subnet according to types of services to be provided to the terminal such that a wireless connection route to the terminal is redundant for each of the types. The managing apparatus includes a route control unit configured to wirelessly connect the terminal to a LAN apparatus corresponding to a type of service requested by the terminal.

A terminal according to still another aspect of the present invention is wirelessly connected to LAN apparatuses that are arranged in plurality in a single subnet according to types of services to be provided to the terminals such that a wireless connection route to the terminals is redundant for each of the types. The terminal includes a service requesting unit configured to transmit information on a type of requesting service to a network side via one of the LAN apparatuses; and a connection control unit configured to connect the terminal to a LAN apparatus on a connection route indicated in a message received from the LAN apparatus in response to transmission of the information.

A method according to still another aspect of the present invention is of controlling a route in a wireless LAN with which a connection route between LAN apparatuses and a terminal. The LAN apparatuses are arranged in plurality in a single subnet according to types of services to be provided to the terminal such that a wireless connection route to the terminal is redundant for each of the types. The method includes transmitting information on a type of a service requested by the terminal to a network side via one of the LAN apparatuses; notifying the terminal of a LAN apparatus that supports the type of the service requested by the terminal; and connecting the terminal to the LAN apparatus notified.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a wireless LAN communication system according to embodiments of the present invention;

FIG. 2 is a schematic of a wireless LAN communication system according to a first embodiment of the present invention;

FIG. 3 is a sequence diagram of a communication route control according to the first embodiment;

FIG. 4 is a schematic of a wireless LAN communication system according to a second embodiment of the present invention;

FIG. 5 is a sequence diagram of a communication route control according to the second embodiment;

FIG. 6 is a schematic of a wireless LAN communication system according to a third embodiment of the present invention;

FIG. 7 is a sequence diagram of a communication route control according to the third embodiment;

FIG. 8 is a schematic of a wireless LAN communication system according to a fourth embodiment of the present invention;

FIG. 9 is a sequence diagram of a communication route control according to the fourth embodiment;

FIG. 10A illustrates a configuration example for managing for each user group by an AP managing server;

FIG. 10B illustrates a configuration example for managing for each tier class in the organization by the AP managing server;

FIG. 10C illustrates a configuration example for managing for each use period in the organization by the AP managing server;

FIG. 11 illustrates a configuration example for managing based on each traffic amount in the organization by the AP managing server; and

FIG. 12 illustrates a configuration example for managing an organization using a round robin by the AP managing server.

### DETAILED DESCRIPTION OF THE PREFERRED EMBODIMENTS

Exemplary embodiments according to the present invention will be explained in detail with reference to the accompanying drawings.

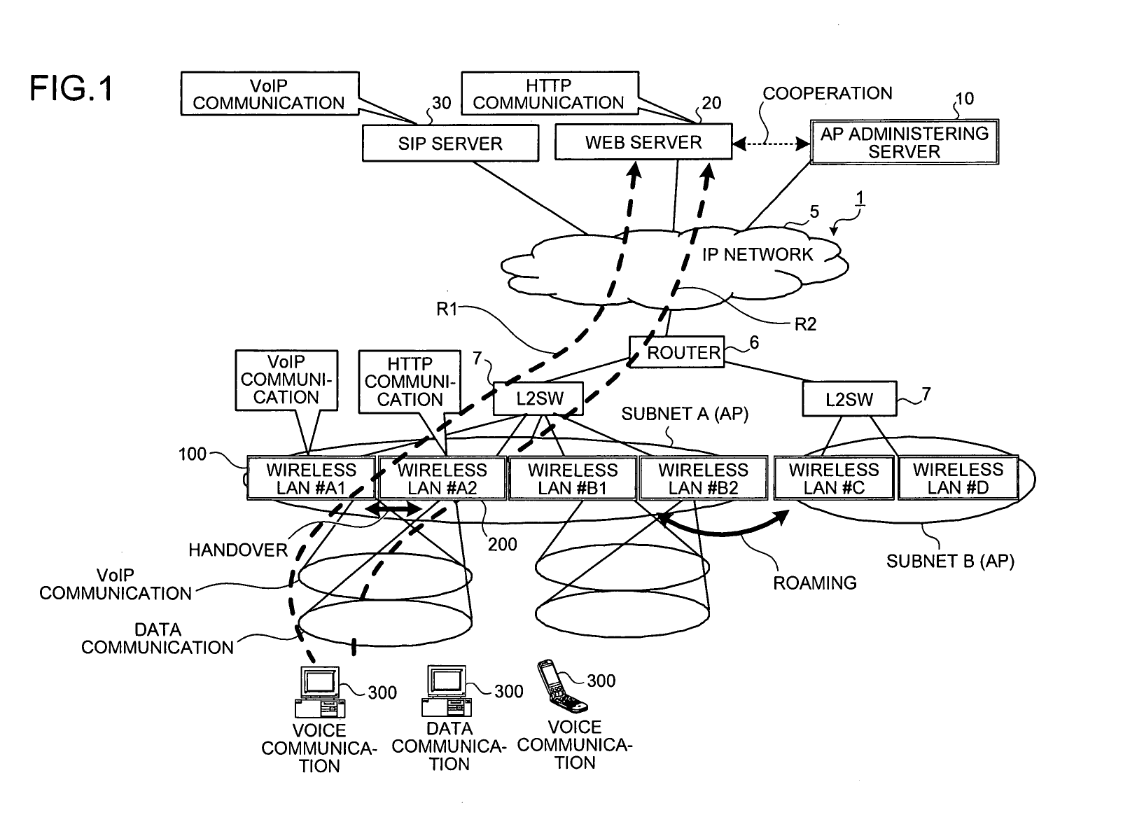

FIG. 1 illustrates a wireless LAN communication system according to embodiments of the present invention. In a wireless LAN system 1, one side an IP network 5 is a server side and the other side is a client side arranged via a wireless LAN apparatus.

On the server side, an AP managing server 10, a web server 20 for an HTTP communication service as a service server, and a session initiation protocol (SIP) server 30 for a VoIP communication service are arranged. The AP managing server 10, cooperating with the web server 20 and the SIP server 30, controls wireless LAN apparatuses 100, 200 arranged respectively at access points (APs) based on the service types, etc. For example, for each service, the AP managing server 10 controls a connection route by selecting the wireless LAN apparatus 100 or the wireless LAN apparatus 200 as the connection destination of a wireless LAN access terminal (access terminal) 300.

On the client side, the wireless LAN apparatuses 100, 200 are arranged in the IP network 5 through a router 6 and a layer2 switch (L2SW) 7. In the present embodiment, a plurality of wireless LAN apparatuses 100, 200 are arranged in a single subnet A (AP). The wireless LAN apparatuses 100, 200 are provided in plurality according to service types. In the example shown, corresponding to the services on the server side, the wireless LAN apparatus 100 is provided for the VoIP communication service and the wireless LAN apparatus 200 is provided for the HTTP communication service. In a single subnet, at least two wireless LAN apparatuses 100, 200 should be provided, and as shown in the subnet A in FIG. 1, four wireless LAN apparatuses (#A1, #A2, #B1, #B2) may be provided.

The access terminal 300 is connected to the wireless LAN apparatus 100 or the wireless LAN apparatus 200 in on of the subnets A to communicate with the apparatus. As shown, this access terminal 300 can execute voice communication (VoIP communication service) and data communication (HTTP communication service). The wireless LAN apparatuses 100, 200 execute handover between themselves for the connection with the access terminal 300 in the subnet A. The handover is executed between the wireless LAN apparatus 100 and the wireless LAN apparatus 200 in accordance with a control of the AP managing server 10. It is assumed that the arrangement of all the wireless LAN apparatuses #A1, #A2, #B1, and #B2 in the subnet A has been set in advance such that the access terminal 300 can equally access all the wireless LAN apparatuses #A1, #A2, #B1, and #B2. The access terminal 300 executes roaming in accordance with a control of the AP managing server 10 when the access terminal 300 moves over subnets (between the subnet A and the subnet B in the example shown) due to a change of location.

When the access terminal 300 executes voice communication (VoIP communication service), the access terminal 300 executes route control to connect to the wireless LAN apparatus 100 for the VoIP communication service in accordance with a control of the AP managing server 10 so that the access terminal 300 is connected to the SIP service 30 through the IP network 5. When the access terminal 300 executes data communication (HTTP communication service), the access terminal 300 executes route control to connect to the wireless LAN apparatus 200 for the HTTP communication service in accordance with a control of the AP managing server 10 so that the access terminal 300 is connected to the web server 20 through the IP network 5. If the access terminal 300 is connected to the wireless LAN apparatus for a service different from a desired service, the access terminal 300 executes handover to a wireless LAN apparatus that is suitable for the desired service in accordance with the AP managing server 10 (switching between route R1 and R2 in the example shown).

While in the above example, the two wireless LAN apparatuses in one subnet is for the VoIP communication service and for the HTTP communication service respectively, another configuration may be applied with wireless LAN apparatuses respectively for a simple mail transfer protocol (SMTP) communication service as an apparatus for transmission/reception of electronic mail, for an FTP communication service, for a telnet communication service, etc. Moreover, wireless LAN apparatuses are not limited to be provided for each type of communication service. Examples of providing a wireless LAN apparatus for each type of other services are listed below.
1. Examples of a service for each user group: a. for each organization; b. for each tier class; and c. for each use period.
2. Examples of a service for each traffic amount in a specific time period; a. a service for each N hours immediately before communication; and b. for same use period of the day before, and an average traffic amount over N days immediately before.
3. Examples of a service according to conditions for each wireless LAN access terminal for which a connection request is made: a. for each round-robin connection; b. for each type of last communication service; and c. for each last communication time.

The above specific examples of application to various services will be described in detail in each embodiment described below.

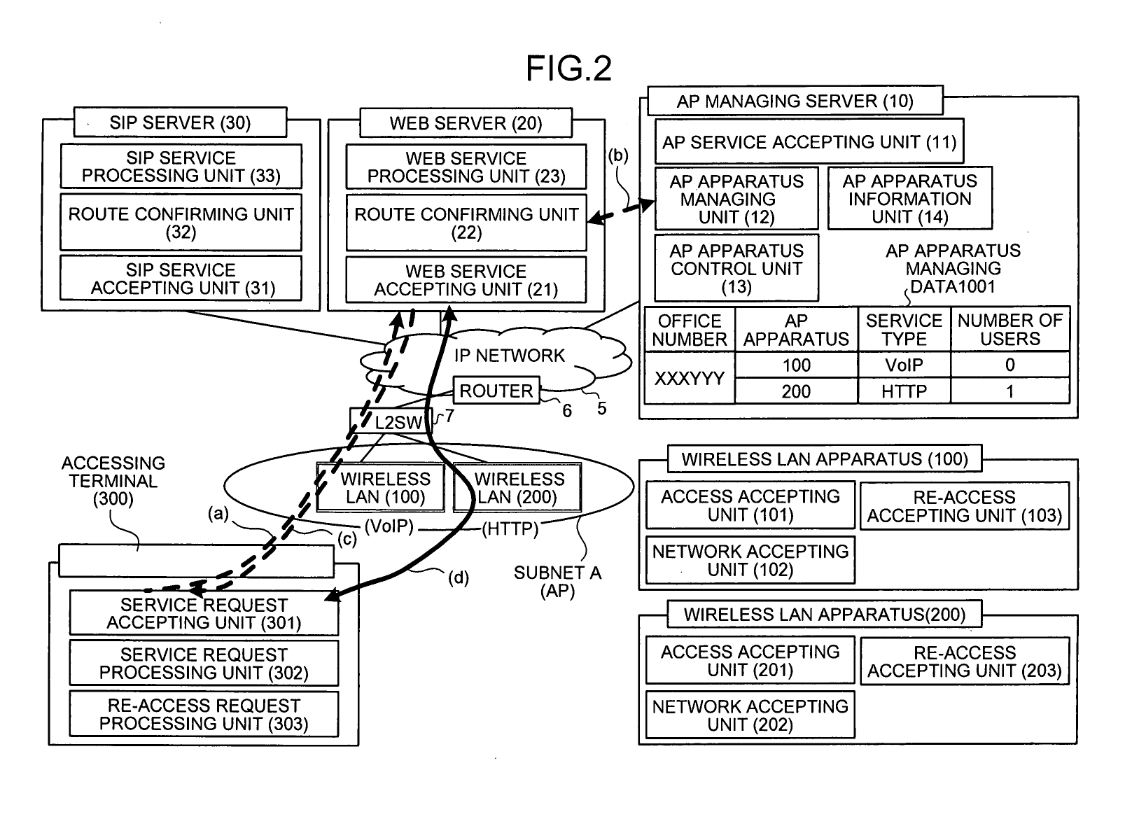

FIG. 2 illustrates a wireless LAN communication system according to a first embodiment of the present invention. Same reference numerals are given to components that are same as those of FIG. 1. In the first embodiment, the system is configured that, based on a connection request from an access terminal (a), the service servers (the web server 20, the SIP server 30), cooperating with the AP managing server 10 (b), responses as to the wireless LAN apparatuses 100, 200 that are suitable for the services (c), and the access terminal 300 starts the communication service through the wireless LAN apparatus 200 corresponding to the service (d).

The AP managing server 10 includes an AP service accepting unit 11, an AP apparatus managing unit 12, an AP apparatus control unit 13, and an AP apparatus information unit 14. These units 11 to 14 function as a route control unit that controls a connection route of the wireless LAN access terminal 300 to the wireless LAN apparatuses 100, 200.

The AP service accepting unit 11 is an I/F that accepts a route confirmation request (and a response thereof), etc. from the web server 20 and the SIP server 30. The AP apparatus control unit 13 controls the wireless LAN apparatuses 100, 200 arranged in the subnet A that are access points (AP). This control is executed based on management settings of the AP apparatus managing unit 12. The AP apparatus managing unit 12, using AP apparatus managing data 1001 stored in the AP apparatus information unit 14, manages the wireless LAN apparatuses 100, 200 to respectively execute communication services set therein. In addition, the AP apparatus information unit 14 stores user managing data (not shown) used when a user is to be authenticated.

The AP apparatus managing data 1001 is stored in a form of table, and in the example shown, items such as office numbers, the communication service type (VoIP, HTTP) respectively of the AP apparatuses (wireless LAN apparatuses) 100, 200, and the number of users are stored. “1” for the number of users indicates that the number of users of the AP apparatus 200 is one (the access terminal 300 is one).

The web server 20 includes a web service accepting unit 21, a route confirming unit 22, and a web service processing unit 23. The web service accepting unit 21 executes a reception process of a request (HTTP request) of a web service from the IP network 5 and issues a route confirmation request to the route confirming unit 22. In response to reception of the route confirmation request, the route confirming unit 22 issues a route confirmation request to the AP managing server 10 that manages the wireless LAN apparatus 200 that executes the web service. The web service processing unit 23 provides the web service by the wireless LAN apparatus 200.

The SIP server 30 includes an SIP service accepting unit 31, a route confirming unit 32, and an SIP service processing unit 33. The SIP service accepting unit 31 executes a reception process of a request (VoIP request) of the SIP service from the IP network 5 and issues a route confirmation request to the route confirming unit 32. When receiving the route confirmation request, the route confirming unit 32 issues a route confirmation request to the AP managing server 10 that manages the wireless LAN apparatus 100 that executes the SIP service. The SIP service processing unit 33 provides the SIP service by the wireless LAN apparatus 100.

The wireless LAN apparatus 100 is arranged for the SIP service and includes a connection control unit (not shown) that connects the access terminal 300 with the IP network 5. In addition, the wireless LAN apparatus 100 includes an access accepting unit 101, a network accepting unit 102, and a re-access accepting unit 103. The access accepting unit 101 executes a process to an access between the apparatus 100 and the access terminal 300. The network accepting unit 102 executes a process for connection with the IP network 5 side (the SIP server 30 or the web server 20). The re-access accepting unit 103 executes a process for disconnection and re-access of connection between the apparatus and the access terminal 300. The wireless LAN apparatus 200 includes a same configuration (201, 202, 203) as that of the wireless LAN apparatus 100 and is arranged for the web service.

The access terminal 300 includes a service request accepting unit 301, a service request processing unit 302, and a re-access request processing unit 303. The service request accepting unit 301 connects by radio to request communication services to the wireless LAN apparatuses 100, 200. The service request processing unit 302 executes a process for a request of a communication service (the web service or the SIP service). When accesses to the wireless LAN apparatuses 100, 200 are disconnected, the re-access request processing unit 303 executes a process to request re-accessing. This access terminal 300 is constituted using a PC, a portable telephone, etc., and has a function that executes the web service or the SIP service. The wireless connection with the wireless LAN apparatus 100, 200 (including the handover and roaming described above) is executed by a connection control unit not shown.

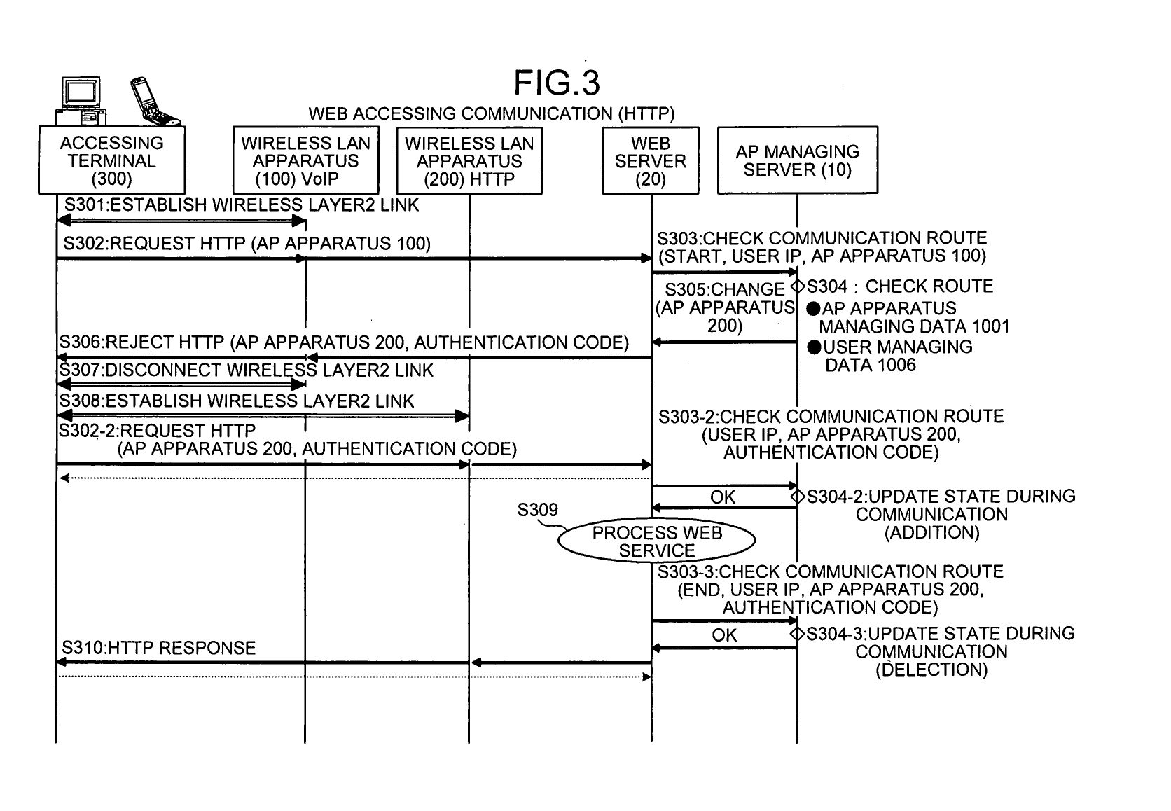

FIG. 3 is a sequence diagram of a communication route control according to the first embodiment. The communication route control according to the first embodiment will be described referring to FIG. 3. It is assumed that the access terminal 300 requests start of the web service (HTTP communication).

When a user starts IP communication from the access terminal 300 that has a wireless LAN function, the service request accepting unit 301 of the access terminal 300 detects the wireless LAN apparatus 100 and the wireless LAN apparatus 200 using the wireless accessing function thereof. According to a fixed logic (an AP having a strong wireless LAN intensity is selected, etc.), the access terminal 300 starts accessing to the nearest wireless LAN apparatus (AP apparatus) 100. This wireless LAN apparatus 100 is for the SIP service (VoIP communication).

After establishing S301 a wireless layer2 link to the wireless LAN apparatus 100, the service request accepting unit 301 of the access terminal 300 transmits an HTTP request S302 to the web server 20 together with “AP apparatus: 100” set in the request. Though a VoIP communication request may be issued based on the SIP protocol, an example of requesting a web service (HTTP communication) will be described in the first embodiment.

Having received the HTTP request S302, the web server 20 executes a reception process using the web service accepting unit 21 and issues a route confirmation request to the route confirming unit 22. Having received the route confirmation request, the route confirming unit 22 issues a route confirmation request (a communication route check: start) S303 to the AP managing server 10 based on “AP apparatus: 100”, “communication service type: HTTP”, and “user information (user IP: an MAC address or an IP address)” on the HTTP request S302.

After accepting S303 the route confirmation request using the AP service accepting unit 11, the AP managing server 10 inquires of the AP apparatus managing unit 12 whether or not the PA apparatus (wireless LAN apparatus) 100 corresponding to the communication service type is appropriate. The AP apparatus managing unit 12 executes a route check S304 based on information managed by the AP apparatus information unit 14 (the AP apparatus managing data 1001) and input “AP apparatus: 100”. In this route check S304, the office number of the user and the communication service type are collected and whether or not the wireless LAN apparatus 100 is appropriate for use for “communication service type: HTTP” is judged.

When the judgment result indicates that the use is appropriate, AP apparatus OK information is returned together with an authentication code attached thereto. However, when the judgment result indicates that the use is not appropriate (in the case shown, the communication service type is wrong), the AP apparatus managing unit 12 searches in the AP apparatus managing data 1001 based on the office number of the user and the communication service type, selects the wireless LAN apparatus 200 that is the AP apparatus that corresponds to “communication service type: HTTP” within a same office number of the user, and returns “CHANGE (message)” S305 together with an authentication code attached thereto to the web server 20.

Having received the response, for the response of the AP apparatus OK information, the route confirming unit 22 of the web server 20 causes the web service processing unit 23 to continue a handover process to continue the communication service process. As the example shown, when the communication service type is wrong and the response is CHANGE (message) S305 of the AP apparatus 200, the route confirming unit 22 returns information of changing the AP apparatus (the wireless LAN apparatus 200) to the web service accepting unit 21. The web service accepting unit 21 returns to the access terminal 300 “HTTP reject (message)” S306 including the information of changing the AP apparatus.

Having received the HTTP reject S306, the access terminal 300 analyses the HTTP reject S306 using the service request accepting unit 301. When the information of changing the AP apparatus is included, the access terminal 300 judges whether or not the changed AP apparatus (the wireless LAN apparatus 200) can be used (selected). When the apparatus can be selected, the access terminal 300 executes wireless layer2 link disconnection S307 with the old wireless LAN apparatus 100 and executes wireless layer2 link establishment S308 with the changed AP apparatus (the wireless LAN apparatus 200) that has been specified by HTTP reject S306.

Thereby, the access terminal 300 transmits newly HTTP request S302-2 “AP apparatus: 200”. Having received the HTTP request S302-2, the web server 20 executes a reception process using the web service accepting unit 21 and executes a process of the communication route check S303-2 similar to the above. At this time, the AP service accepting unit 11 of the AP managing server 10 checks the normality of the AP apparatus managing unit 12 based on the information on the wireless LAN apparatus 200 and the authentication code thereof and, thereafter, changes (S304-2) the number of users of the AP apparatus managing data 1001 concerning the wireless LAN apparatus 200 that has been newly added with a user. In the case shown, as in FIG. 2, the number of users is changed to “1” that has bee added with the new one user. Thereafter, a process of a web service S309 by a route of the web server 20 to the wireless LAN apparatus 200 to the access terminal 300 is executed. Depending on an HTTP message, only the normality may be checked to the AP apparatus managing unit 12 in the route check based on the wireless LAN apparatus 200 and the authentication code thereof.

Thereafter, at the end of the web service S309, when the web service processing unit 23 of the web server 20 returns an HTTP response S310 to the access terminal 300, the unit 23 issues a web service end request to the route confirming unit 22 according to a communication route check S303-3 based on “AP apparatus”, “communication service type: HTTP”, and “user IP (a MAC address or an IP address)”. The route confirming unit 22 of the web server 20 delivers the request of the communication route check (end) to the AP service accepting unit 11 of the AP managing server 10. Accepting the web service end request, the AP service accepting unit 11 updates (deletes) (S304-3) the number of users from the information on the corresponding wireless LAN apparatus (the AP apparatus managing data 1001) to the AP apparatus managing unit 12 based on the input information.

As another example of the above update (deleting) of the users of the AP apparatus managing data 1001, when the web service processing unit 23 of the web server 20 returns the HTTP response S310 to the access terminal 300, the web server 20 sets an ON flag to the use state of the corresponding access terminal 300 and returns a response to the access terminal 300 without passing through the route confirming unit 22. To monitor the state of the AP apparatuses (in this case, the wireless LAN apparatus 200) for each user using the system, the AP apparatus managing unit 12 of the AP managing server 10 checks the use state of the access terminal 300 in the web service processing unit 23 of the web server 20 at a constant time interval. When the use state is ON (used), the managing server 10 resets the state to OFF. When the use state is OFF, the managing server 10 determines that the communication of the corresponding access terminal 300 is disconnected and deletes the corresponding access terminal from the AP apparatus managing data 1001.

In the procedure of the above route control, the authentication code of the result to the HTTP request S302 is included in the HTTP reject S306. That is, this is a state indicating that the AP managing server 10 has authenticated the access from the access terminal 300. Having accepted this HTTP reject S306, the access terminal 300 does not have to make any requirement to the service server (the web server 20) later and can reduce the number of times of requiring.

According to the first embodiment described above, when connecting with a network though the wireless LAN apparatus of the AP, the wireless LAN apparatus to be used for the VoIP communication and the wireless LAN apparatuses to be used for other communication (for example, HTTP communication) can be separated from each other. Therefore, each communication service can be stably provided. For example, the quality of the voice service by VoIP communication can be secured.

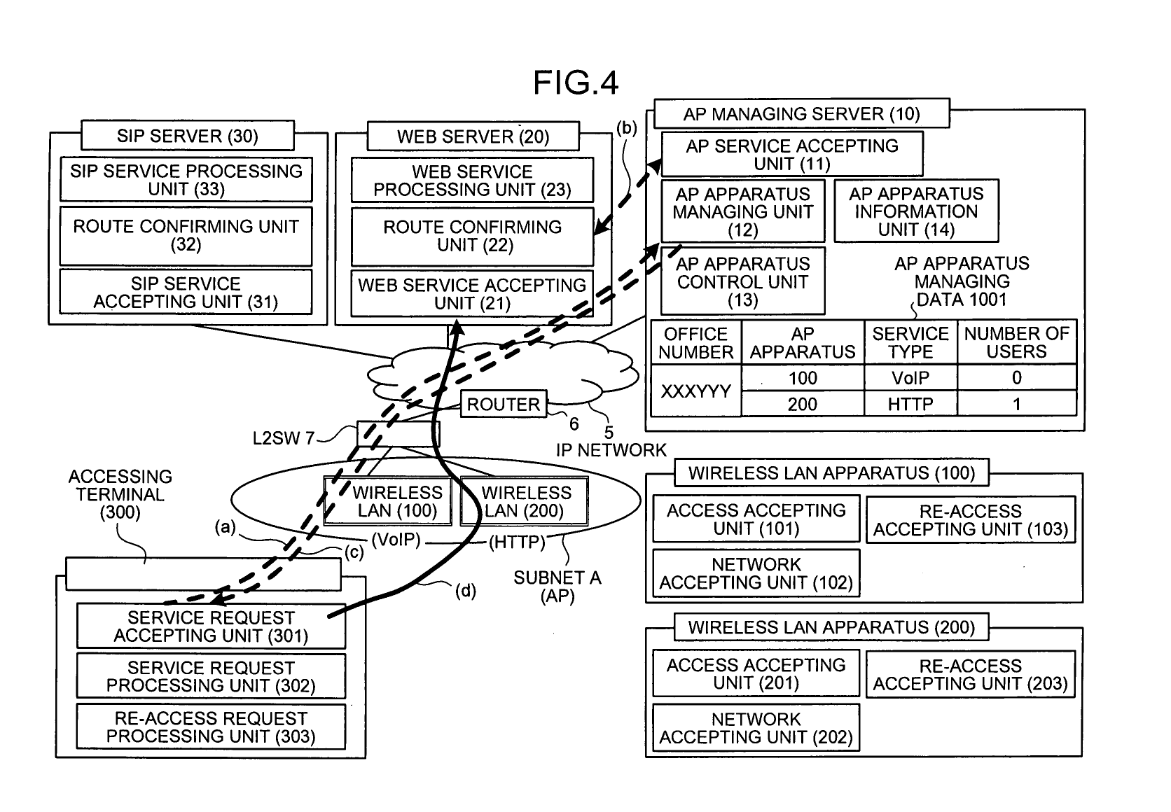

FIG. 4 illustrates a wireless LAN communication system according to a second embodiment of the present invention. Same reference numerals are given to components that are same as those of FIG. 1. According to the second embodiment of the present invention, the system is configured that, before an access terminal starts a service utilizing the nearest wireless LAN apparatus, the access terminal accesses the AP managing server 10 (a), the AP managing server 10 cooperates with the service servers (the web server 20 and the SIP server 30) (b), and returns information on the wireless LAN apparatus type and the service server that the AP managing server 10 uses for the corresponding service to the access terminal 300 (c), and the access terminal 300 starts the communication service through the corresponding wireless LAN apparatus (d).

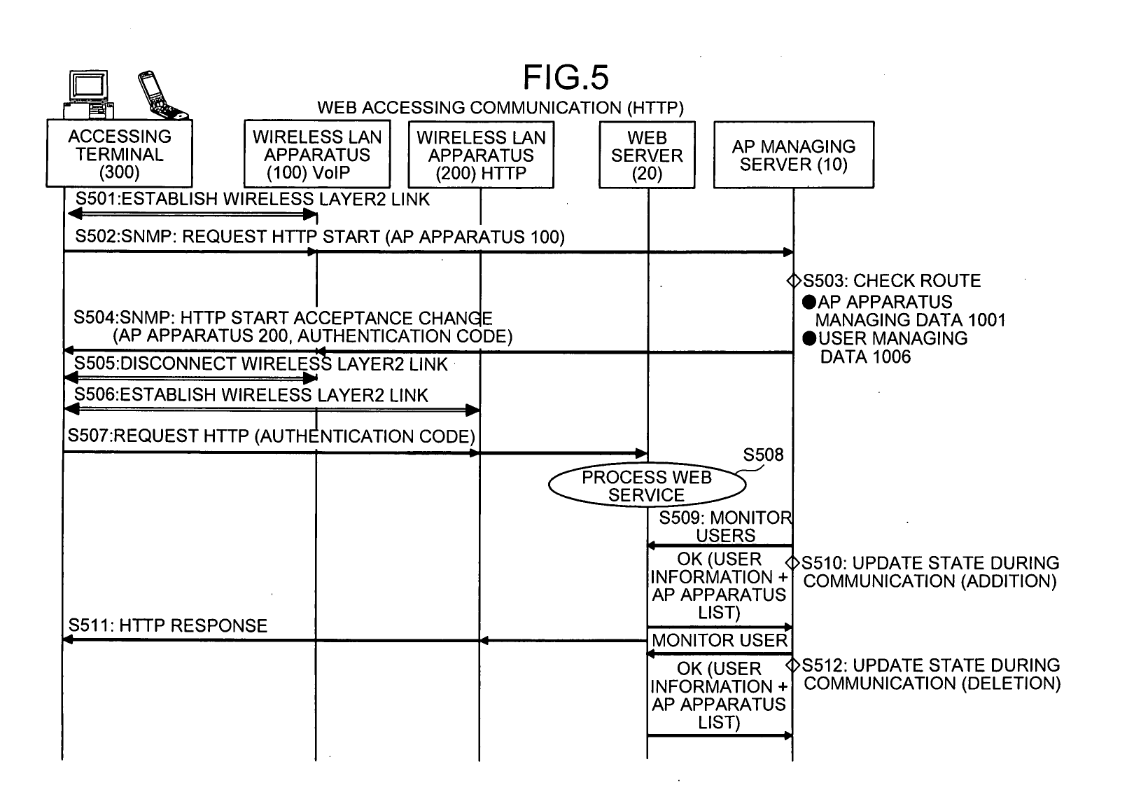

FIG. 5 is a sequence diagram of a communication route control according to the second embodiment. The communication route control according to the second embodiment will be described using FIG. 5. It is assumed that the access terminal 300 requests start of the web service (HTTP communication).

When a user starts IP communication by the access terminal 300 having the wireless LAN function, the service request accepting unit 301 of the access terminal 300 detects the wireless LAN apparatus 100 and the wireless LAN apparatus 200 using the wireless accessing function thereof. According to a fixed logic (an AP having a strong wireless LAN intensity is selected, etc.), the access terminal 300 starts accessing to the nearest wireless LAN apparatus (AP) 100. This wireless LAN apparatus 100 is for the SIP service (VoIP communication).

After establishing S501 a wireless layer2 link to the wireless LAN apparatus 100, the service request accepting unit 301 of the access terminal 300 issues an HTTP service start request (S502) to the AP managing server 10 using an managing communication protocol such as SNMP, etc. This HTTP service start request is executed with parameters for each type of AP apparatus (the wireless LAN apparatus 100) being used that are added to an HTTP service start request message. The SIP protocol may be configured to issue a VoIP communication request based on the SIP protocol.

Having received the HTTP service start request, the AP managing server 10, using the AP service accepting unit 11, issues a route confirmation request (a route check S503) to the AP apparatus managing unit 12 based on “AP apparatus: 100” that is the type of the wireless LAN apparatus being used in the HTTP service start request, “communication service type: HTTP”, and “user information” as parameters. The AP apparatus managing unit 12 collects the office number of the user and the communication service type based on information managed by the AP apparatus information unit 14 (the AP apparatus managing data 1001) and input “AP apparatus: 100”, and judges whether or not the wireless LAN apparatus 100 is appropriate for use for “communication service type: HTTP”.

When the judgment result indicates that the use is appropriate, AP apparatus OK information is returned together with web server information of the access destination attached thereto. However, when the judgment result indicates that the use is not appropriate (in the case shown, the communication service type is wrong), the AP apparatus managing unit 12 searches in the AP apparatus managing data 1001 based on the office number of the user and the communication service type, determines an AP apparatus (the wireless LAN apparatus 200) that corresponds to “communication service type: HTTP” within a same office of the user, and returns a response (including the AP apparatus CHANGE information together with the access destination web server information) of HTTP start acceptance using SNMP (S504).

Having received the HTTP service start acceptance S504, the service request accepting unit 301 of the access terminal 300 transmits an HTTP request based on the web server information in the received HTTP service start acceptance S504 when the response indicates AP apparatus OK and, thereby, starts the HTTP service. As shown, when the response indicates AP apparatus CHANGE, the service request accepting unit 301 judges whether or not an apparatus is a selectable wireless LAN apparatus based on the AP apparatus CHANGE information in the HTTP service start acceptance S504. When the apparatus is a selectable wireless LAN apparatus, wireless layer2 link disconnection S505 with the old wireless LAN apparatus (the wireless LAN apparatus 100) is executed and wireless layer2 link establishment S506 with the changed AP apparatus (the wireless LAN apparatus 200) is executed and, thereafter, transmits an HTTP request S507 based on the web server information in the received HTTP service start response message. Thereby, the web service S508 by the HTTP communication is started.

The AP apparatus managing unit 12 of the AP managing server 10 executes user monitoring S509 to the web server 20 and updates (S510) the number of users of the AP apparatus managing data 1001 concerning the wireless LAN apparatus 200 that has been newly added based on the wireless LAN apparatus 200 and the authentication code information.

Thereafter, at the end of the web service S508, when the web service processing unit 23 of the web server 20 returns an HTTP response S511 to the access terminal 300, the AP apparatus managing unit 12 issues a web service end request to the route confirming unit 22 based on “AP apparatus”, “communication service type: HTTP”, and “user information (a MAC address or an IP address)”. The route confirming unit 22 delivers the request to the AP service accepting unit 11 of the AP managing server 10. Accepting the web service end request, the AP service accepting unit 11 updates (deletes) (S512) the number of users from the corresponding AP apparatus information (the AP apparatus managing data 1001) to the AP apparatus managing unit 12 based on the input information.

As another example of the above update (deleting) of the users of the AP apparatus managing data 1001, when the web service processing unit 23 of the web server 20 returns the HTTP response S511 to the access terminal 300, the web server 20 sets an ON flag to the use state of the corresponding access terminal 300 and returns a response to the access terminal 300 without passing through the route confirming unit 22. To monitor the state of the AP apparatuses (in this case, the wireless LAN apparatus 200) for each user using the system, the AP apparatus managing unit 12 of the AP managing server 10 checks the use state of the access terminal of the web service processing unit 23 of the web server 20 at a constant time interval. When the use state is ON (used), the managing server 10 resets the state to be OFF. When the use state is OFF, the managing server 10 determines that the communication of the corresponding access terminal 300 is disconnected and deletes the corresponding access terminal from the AP apparatus managing data 1001.

According to the second embodiment described above, similarly to the first embodiment, when connecting with a network though the wireless LAN apparatus of the AP, the wireless LAN apparatus to be used for the VoIP communication and the wireless LAN apparatuses to be used for other communication (for example, HTTP communication) can be separated from each other. Therefore, each communication service can be stably provided. According to the second embodiment, before the communication service is started, the wireless LAN apparatus of the AP used between the access terminal and the AP managing server on the service-providing side can be determined in advance. Therefore, allotment of the wireless LAN apparatuses in the AP (assignment for each communication service type) is enabled without changing the communication service procedure compared to the first embodiment.

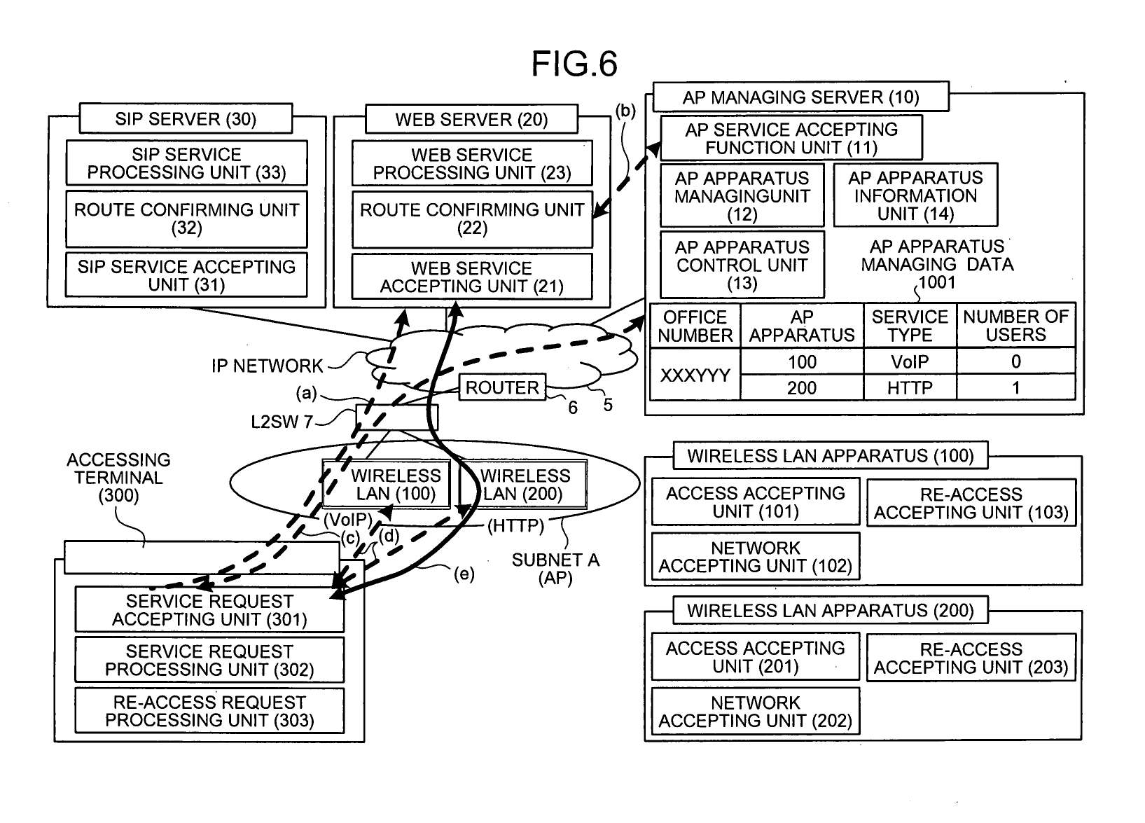

FIG. 6 illustrates a wireless LAN communication system according to a third embodiment of the present invention. Same reference numerals are given to components that are same as those of FIG. 1. According to the third embodiment of the present invention, the system is configured that, when an access terminal starts a service utilizing the nearest wireless LAN apparatus (a), the service servers (the web server 20 and the SIP server 30) inquire of the AP managing server 10 (b), the AP managing server 10 selects the wireless LAN apparatus 200 corresponding to the service (c), the access terminal 300 is forced to hand over to the selected wireless LAN apparatus 200 (d), and the access terminal starts the communication service through the corresponding wireless LAN apparatus (e).

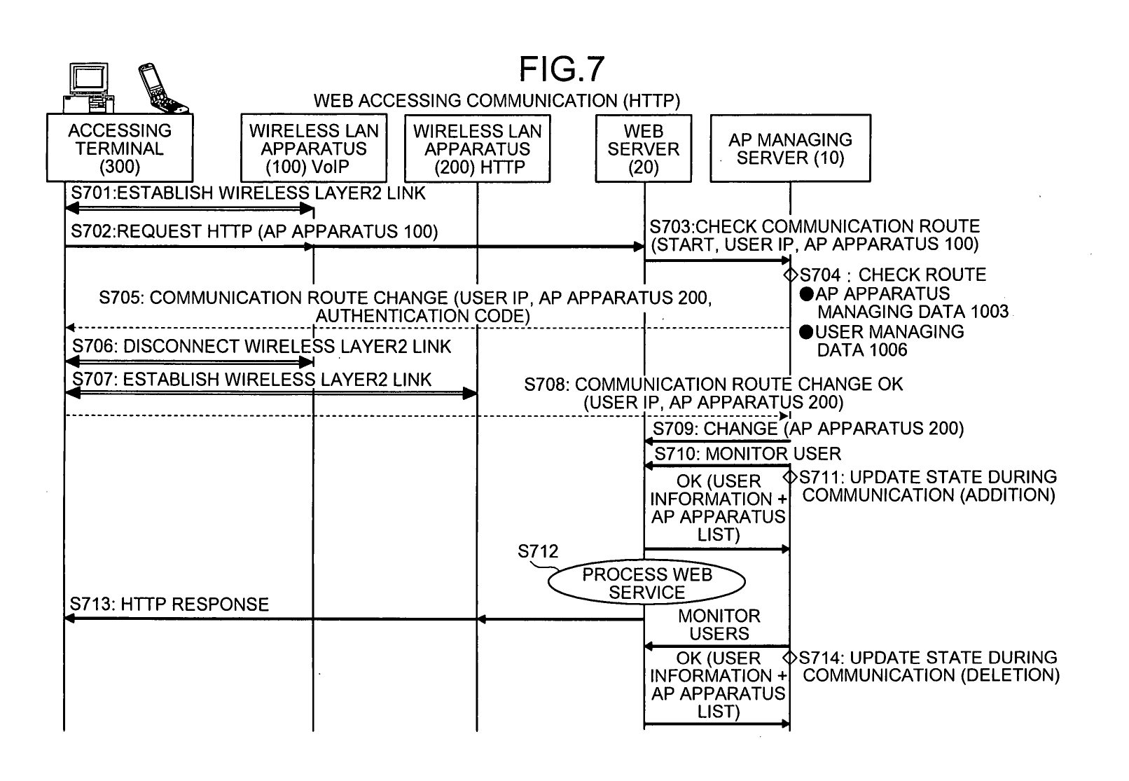

FIG. 7 is a sequence diagram of a communication route control according to the third embodiment. The communication route control according to the third embodiment will be described using FIG. 7. It is assumed that the access terminal 300 requests start of the web service (HTTP communication).

When a user starts IP communication from the access terminal 300 that has a wireless LAN function, the service request accepting unit 301 of the access terminal 300 detects the wireless LAN apparatus 100 and the wireless LAN apparatus 200 using the wireless accessing function thereof. According to a fixed logic (an AP having a strong wireless LAN intensity is selected, etc.), the access terminal 300 starts accessing to the nearest wireless LAN apparatus (AP) 100. This wireless LAN apparatus 100 is for the SIP service (VoIP communication).

After establishing S701 a wireless layer2 link to the wireless LAN apparatus 100, the service request accepting unit 301 of the access terminal 300 transmits an HTTP request to the web server 20 together with “AP apparatus: 100” set in the request. Though a VoIP communication request may be issued based on the SIP protocol, an example applied to an HTTP service will be described in the third embodiment.

Having received the HTTP request, the web server 20 executes a reception process using the web service accepting unit 21 and issues a route confirmation request to the route confirming unit 22. Having received the route confirmation request, the route confirming unit 22 issues a route confirmation request (a communication route check S703) to the AP managing server 10 based on “AP apparatus: 100”, “communication service type: HTTP”, and “user information (an MAC address or an IP address)” on the HTTP request. After accepting the route confirmation request using the AP service accepting unit 11, the AP managing server 10 inquires of the AP apparatus managing unit 12 whether or not the wireless LAN apparatus 100 corresponding to the communication service type is appropriate. The AP apparatus managing unit 12 collects the office number of the user and the communication service type based on the AP apparatus managing data 1001 managed by the AP apparatus information unit 14 and the input “AP apparatus: 100” and judges whether or not the wireless LAN apparatus 100 is appropriate for use for “communication service type: HTTP” (route check S704).

When the judgment result indicates that the use is appropriate, AP apparatus OK information is transmitted together with an authentication code attached thereto as “communication OK instruction” to the access terminal 300. However, when the judgment result indicates that the use is not appropriate (in the case shown, the communication service type is wrong), the AP apparatus managing unit 12 searches in the AP apparatus managing data 1001 based on the office number of the user and the communication service type, determines the AP apparatus (wireless LAN apparatus 200) that corresponds to “communication service type: HTTP” within a same office number of the user, and transmits to the access terminal 300 “communication route CHANGE (S705)” using a maintenance communication protocol such as SNMP, etc. This communication route CHANGE S705 instructs “forced handover” with an authentication code directly to the access terminal 300.

Having received the communication route CHANGE (S705) including this “forced handover instruction”, the access terminal 300 transmits “forced handover completion notice” according to the communication route CHANGE OK (S708) using the maintenance communication protocol such as SNMP, etc., after the service request accepting unit 301 executes communication layer2 link disconnection S706 with the old wireless LAN apparatus (wireless LAN apparatus 100) and executes communication layer2 establishment S707 with the changed AP apparatus (wireless LAN apparatus 200).

Thereafter, the AP apparatus managing unit 12 returns CHANGE (“AP apparatus OK” or “AP apparatus CHANGE completed”) S709 to the route confirming unit 22 of the web server 20. The AP apparatus managing unit 12 of the AP managing server 10 executes user monitoring S710 to the web server 20 and updates (S711) the number of users of the AP apparatus managing data 1001 concerning the wireless LAN apparatus 200 that has been newly added with a user based on the wireless LAN apparatus 200 and the authentication code information. The web server 20 starts the web service S712 by HTTP communication with the access terminal 300.

Thereafter, at the end of the web service S712, when the web service processing unit 23 of the web server 20 returns an HTTP response S713 to the access terminal 300, the AP apparatus managing unit 12 issues a web service end request to the route confirming unit 22 based on “AP apparatus”, “communication service type: HTTP”, and “user information (a MAC address or an IP address)”. The route confirming unit 22 delivers the request to the AP service accepting unit 11 of the AP managing server 10. Accepting the web service end request, the AP service accepting unit 11 updates (deletes) (S714) the number of users from the information on the corresponding wireless LAN apparatus (the AP apparatus managing data 1001) to the AP apparatus managing unit 12 based on the input information.

As another example of the above update (deleting) of the users, when the web service processing unit 23 of the web server 20 returns the HTTP response to the access terminal 300, the web server 20 sets an ON flag to the use state of the corresponding access terminal 300 and returns a response to the access terminal 300 without passing through the route confirming unit 22. To monitor the state of the AP apparatuses (the wireless LAN apparatus 200) for each user using the system, the AP apparatus managing unit 12 checks the use state of the access terminal in the web service processing unit 23 of the web server 20 at a constant time interval. When the use state is ON (used), the managing server 10 resets the state to be OFF. When the use state is OFF, the managing server 10 determines that the communication of the corresponding access terminal 300 is disconnected and deletes the corresponding access terminal from the AP apparatus managing data 1001.

According to the third embodiment described above, when connecting with a network though the wireless LAN apparatus of the AP, the wireless LAN apparatus to be used for the VoIP communication and the wireless LAN apparatuses to be used for other communication (for example, HTTP communication) can be separated from each other. Therefore, each communication service can be stably provided. Because the switching of the wireless LAN apparatuses of the AP is executed lead by the AP managing server, influence of the load of the process executed by the service server (the web server 20) can be minimized even when a change has been made to the AP controlling scheme, compared with the first embodiment.

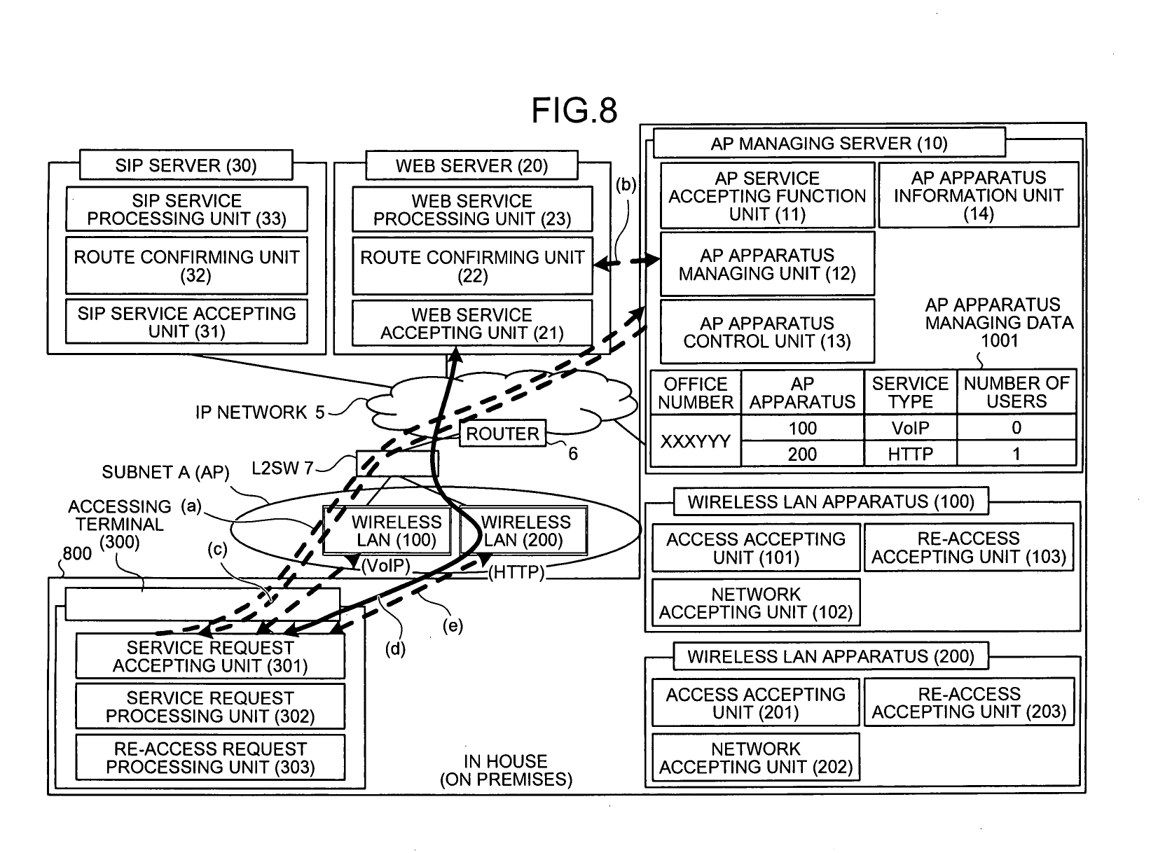

FIG. 8 illustrates a wireless LAN communication system according to a fourth embodiment of the present invention. Same reference numerals are given to components that are same as those of FIG. 1. According to the fourth embodiment, as shown, the system is configured that the AP managing server 10 is provided in a house (or on the premises) 800 and manages the wireless LAN apparatuses 100, 200 in this house. Before the access terminal 300 starts accessing through the nearest wireless LAN apparatus, the access terminal 300 inquires of the AP managing server 10 (a), the AP managing server 10 collects information on the wireless LAN apparatus 200 and the service server (the web server 200) that correspond to the service (b), selects the wireless LAN apparatus 200 (c), causes the access terminal 300 to forcedly hand over to this selected wireless LAN apparatus 200 (d), and the access terminal 300 starts the communication service through the corresponding wireless LAN apparatus (e).

The function of the AP managing server 10 may be provided to either of the wireless LAN apparatuses 100 and 200 in the house (or on the premises).

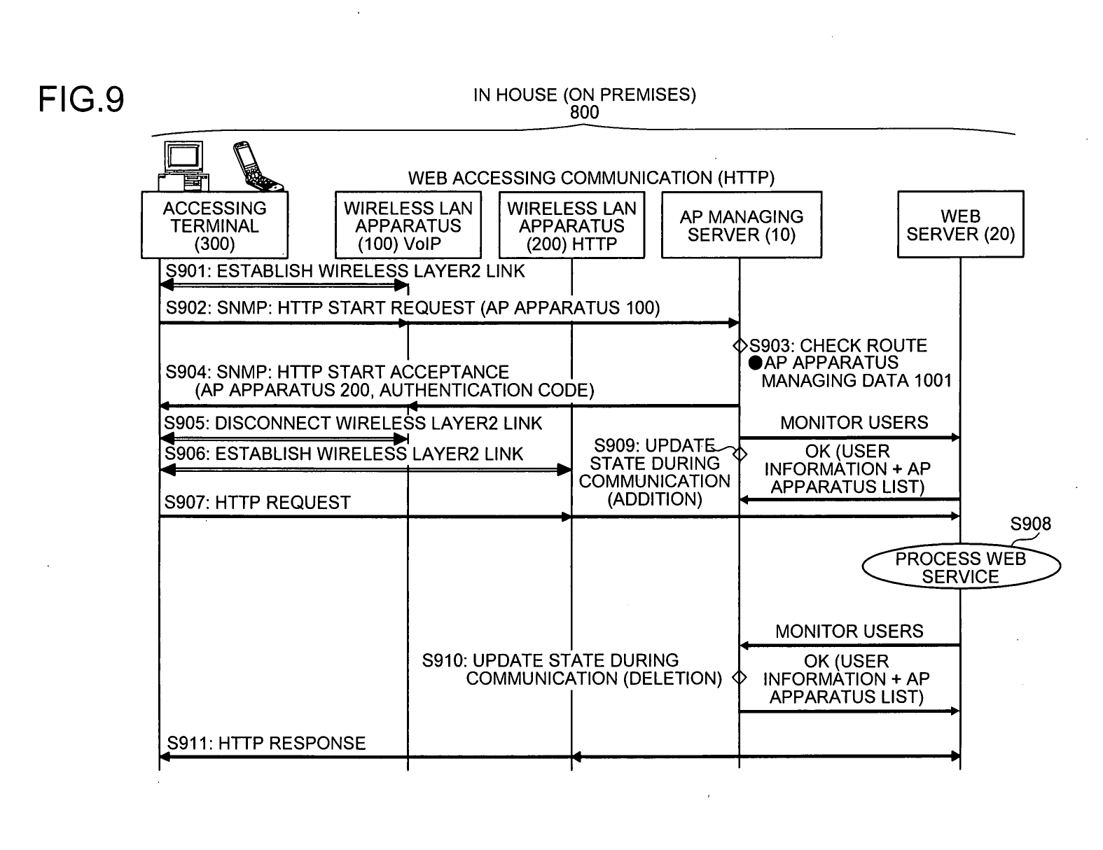

FIG. 9 is a sequence diagram of a communication route control according to the fourth embodiment. The communication route control according to the fourth embodiment will be described using FIG. 9. It is assumed that the access terminal 300 requests start of the web service (HTTP communication).

When a user starts IP communication from the access terminal 300 that has a wireless LAN function, the service request accepting unit 301 of the access terminal 300 detects the wireless LAN apparatus 100 and the wireless LAN apparatus 200 using the wireless accessing function thereof. According to a fixed logic (an AP having a strong wireless LAN intensity is selected, etc.), the access terminal 300 starts accessing to the nearest wireless LAN apparatus (AP). This wireless LAN apparatus 100 is for the SIP service (VoIP communication).

After establishing S901 a wireless layer2 link to the wireless LAN apparatus 100, the service request accepting unit 301 of the access terminal 300 issues an HTTP service start request to the AP managing server 10 in the house (or on the premises) (S902) using the managing communication protocol such as SNMP, etc. This HTTP service start request is executed using an HTTP service start request message added with parameters for each type of AP apparatus (the wireless LAN apparatus 100) being used. The VoIP communication request may be configured to be executed based on the SIP protocol.

Having received the HTTP service start request S902, the AP managing server 10, using the AP service accepting unit 11, issues a route confirmation request (a route check S903) to the AP apparatus managing unit 12 based on “AP apparatus: 100” that is the type of the wireless LAN apparatus being used in the HTTP service start request S902, “communication service type: HTTP”, and “user information” as parameters. The AP apparatus managing unit 12 collects the user type and the communication service type based on the AP apparatus managing data 1001 managed by the AP apparatus information unit 14 and the input “AP apparatus: 100”, and judges whether or not the wireless LAN apparatus 100 is appropriate for use for “communication service type: HTTP”.

When the judgment result indicates that the use is appropriate, AP apparatus OK information is returned together with the web server information of the access destination attached thereto. However, when the judgment result indicates that the use is not appropriate (in the case shown, the communication service type is wrong), the AP apparatus managing unit 12 searches in the AP apparatus managing data 1001 based on the user type and the communication service type, determines an AP apparatus (the wireless LAN apparatus 200) that corresponds to “communication service type: HTTP” within a same radio wave area (the subnet A), and returns a response (including AP apparatus CHANGE information together with the access destination web server information) of HTTP service start acceptance using SNMP (S904).

Having received the HTTP service start acceptance S904, the service request accepting unit 301 of the access terminal 300 transmits an HTTP request based on the web server information in the received HTTP service start response message when the response indicates AP apparatus OK and, thereby, starts the HTTP service. As shown, when the AP apparatus is wrong, the service request accepting unit 301 judges whether or not an apparatus is a selectable wireless LAN apparatus based on the information on the AP apparatus in the HTTP service start acceptance S904. When the apparatus is a selectable wireless LAN apparatus, wireless layer2 link disconnection S905 with the old wireless LAN apparatus (the wireless LAN apparatus 100) is executed and wireless layer2 link establishment S906 with the changed AP apparatus (the wireless LAN apparatus 200) is executed and, thereafter, transmits an HTTP request S907 addressing the request to the web server based on the web server information in the received HTTP service start response message. Thereby, the web service S908 by the HTTP communication is started.

When receiving the HTTP request S907, the web service accepting unit 21 of the web server 20 notifies the route confirming unit 22 of the information of the access terminal 300 and the AP apparatus (the wireless LAN apparatus 200). The route confirming unit 22 updates (addition) (S909) the state of the corresponding access terminal 300 to being in communication based on the notified information on the access terminal 300 and the AP apparatus (the wireless LAN apparatus 200).

Thereafter, at the end of the web service S908, when the web service processing unit 23 of the web server 20 returns an HTTP response S911 to the access terminal 300, the AP apparatus managing unit 12 issues a web service end request to the route confirming unit 22 based on “AP apparatus”, “communication service type: HTTP”, and “user information (a MAC address or an IP address)”. According to the web service end request, the AP service accepting unit 11 updates (deletes) (S910) the number of users from the corresponding AP apparatus information (the AP apparatus managing data 1001) to the AP apparatus managing unit 12.

The communication state of the user and the AP apparatus (wireless LAN apparatus) is monitored non-synchronously from now on. More specifically, due to the end of the web service S908, the route confirming unit 22 of the web server 20 updates the state of the corresponding access terminal 300 to be non-communicating state based on the user information and the information on the AP apparatus.

This route confirming unit 22 usually retains for each AP managing server 10 pieces of information that are user information, the service type, the AP apparatus for a user (the access terminal 300) being in communication. The AP managing server 10 inquires using SNMP protocol, etc., regularly of the web server 20 as to the state of the user during communication under the AP managing server 10. Having received the inquiry, the route confirming unit 22 of the web server 20 returns the user information, the AP apparatus, and the communication service type as the state during communication of the user under the corresponding AP managing server 10. The AP managing server 10 selects an AP apparatus to be used (the wireless LAN apparatuses 100, 200) based on the user information and the service type that have been received. When the selected AP apparatus coincides with the AP apparatus that has been received from the web server 20, the AP managing server 10 executes nothing. When the selected AP apparatus does not coincides with the received AP apparatus, the AP managing server 10 outputs an appropriate AP apparatus that corresponds to the user and the service type, and transmits an AP apparatus switching instruction to urge the corresponding access terminal 300 to switch to the AP apparatus to be used using SNMP protocol, etc. Having received the AP apparatus switching instruction, the access terminal 300 executes wireless layer2 link disconnection of the AP apparatus being used, executes wireless layer2 link establishment with the AP apparatus that has been specified by the AP managing server 10, and continues the communication service.

According to the fourth embodiment described above, the influence on the service server side can be minimized by disposing the AP managing server in a house or a company (on the premises). APs can be utilized for each house or on the premises of each company following an operation policy that has been set in advance (for example, the quality of a voice service should be secured, etc.) by employing the scheme that switches AP apparatuses between access terminals and between AP managing servers.

A fifth embodiment of the present invention is configured to control a wireless LAN apparatus of an AP as to a route for each predetermined group in an organization set in advance. The AP apparatus information unit 14 in the AP managing server 10 described in the first embodiment to the fourth embodiment described above is configured to manage the AP apparatus managing data 1001 based on the communication service type. In contrast, this the fifth embodiment differs from those embodiments in that the AP managing server 10 manages the data 1001 based on a predetermined group. Therefore, the configuration in the fifth embodiment is basically same as that of the first embodiment (FIG. 2) and the description thereof is omitted. Though the route control procedure in this embodiment is basically same as that of the first embodiment (FIG. 3), the procedure differs in that the route is controlled based on a predetermined group in the fifth embodiment.

This group can be set by a service administrator, etc., through a predetermined interface, for example a web interface (not shown) that is accessible to the AP apparatus information unit 14 of the AP managing server 10.

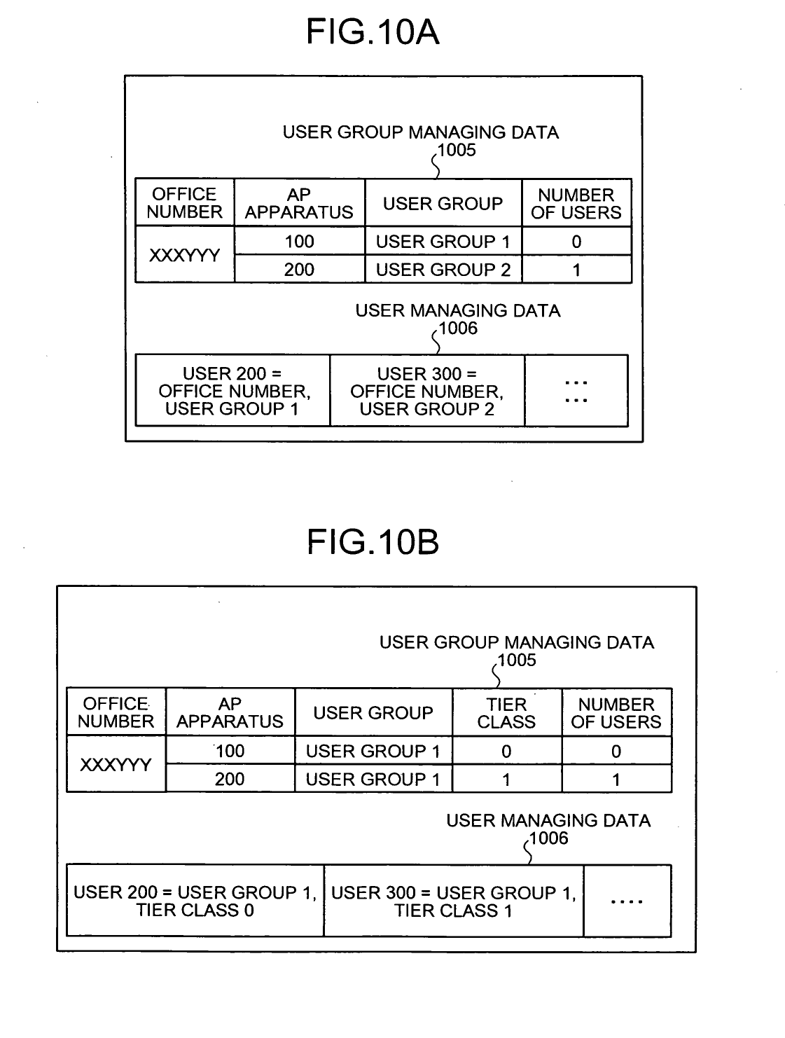

FIG. 10A illustrates a configuration example for managing for each user group in the organization by the AP managing server. The AP apparatus information unit 14 of the AP managing server 10 (see FIG. 2) manages user group managing data 1005 and user managing data 1006. The service administrator or a user administrator sets a plurality of user groups using the user group managing data 1005 and makes settings to assign each user to respectively a user group using the user managing data 1006.

The user group managing data 1005 are stored in the form of a table and consists of, in the example shown, the office number, the user group type “user group 1, 2” respectively of the AP apparatuses (wireless LAN apparatus) 100, 200, and the number of users “0, 1”. “1” for the number of users indicates that the user of the AP apparatus 200 is one (the access terminal 300 is one). The user managing data 1006 consists of, in the example shown, ID numbers “200, 300, etc.” of the user (the access terminal 300), the corresponding office number, and user group types “1 , 2”.

According to the above configuration, routes can be set being assigned to each of the user groups 1, 2 that is belonged by the access terminals 300 of the users that use the wireless LAN apparatuses 100, 200 (see, for example, FIG. 2). The user groups can be set as, for example, groups that respectively differ for each section.

FIG. 10B illustrates a configuration example for managing for each tier class in the organization by the AP managing server. The AP apparatus information unit 14 manages the user group managing data 1005 and the user managing data 1006. The user group managing data 1005 consists of, in the example shown, the office number, the user group type “user group 1” of the AP apparatuses (wireless LAN apparatuses) 100, 200, tier classes “0, 1”, and the number of users “0, 1”. In the example of this figure, the user group type is only one that is “1” for convenience. The user managing data 1006 consists of, in the example shown, ID numbers “200, 300, etc.” of the user (the access terminal 300), the corresponding user group type “1”, and tier classes “0, 1”.

According to the above settings, routes can be set being assigned to each tier class 0, 1 that is belonged by the access terminals 300 of the users that use the wireless LAN apparatuses 100, 200 (see, for example, FIG. 2). The tier class can be set as, for example, a class that differs for each position in a company.

FIG. 10C illustrates a configuration example for managing for each use period in the organization by the AP managing server. The AP apparatus information unit 14 manages the user group managing data 1005 and the user managing data 1006. The user group managing data 1005 consists of, in the example shown, the office number, a plurality of AP apparatus (wireless LAN apparatuses) 100, 200, NNN, arranged in the one subnet A, user group types “user group 1, 2” set for each AP apparatus, the use period of use “time setting” of each user group, and the number of users “0, 1”. For example, though the AP apparatus (wireless LAN apparatus) 200 is used by the user groups 1, 2, the user group 1 is allowed to use for the time period of 5:00 p. m. to 12:00 p. m. and the user group 2 is allowed to use for the time period of 9:00 a. m. to 12:00 p. m. The user managing data 1006 consists of, in the example shown, ID numbers of the user (the access terminal 300) “200, 300, etc.”, and the corresponding user group types “1, 2”.

According to the above settings, the access terminal 300 that uses the wireless LAN apparatuses 100, 200 (see, for example, FIG. 2) can set routes being assigned for each use period of use.

According to the fifth embodiment described above, an operator of a network service or an administrator of users using a system in each house or a company can set use of the wireless LAN apparatus for each user group, each tier, each use period of use, and can cope flexibly with changes made to an organization. Occurrence of a temporary network fault can be coped with by only changing the design of the network.

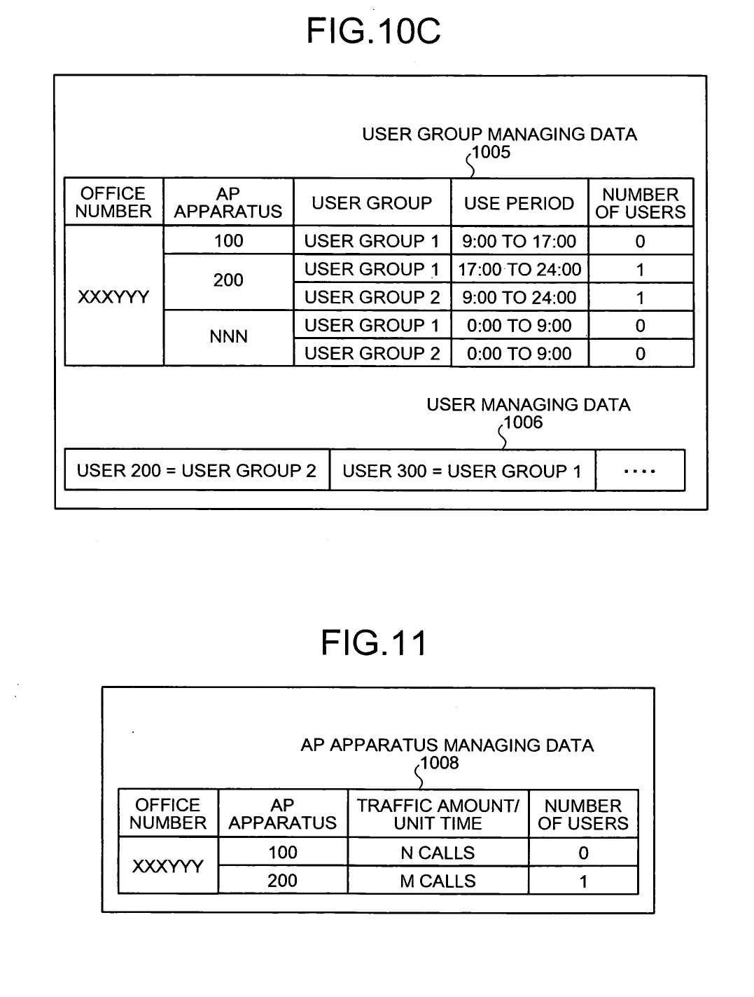

A sixth embodiment of the present invention is configured to control the wireless LAN apparatus of an AP for a route for each traffic amount for a predetermined time period. FIG. 11 illustrates a configuration example for managing based on each traffic amount in the organization by the AP managing server.

The AP apparatus information unit 14 of the AP managing server 10 (see, for example, FIG. 2) manages AP apparatus managing data 1008. This AP managing server 10 is, in addition, provided with a traffic amount calculating unit (not shown). This traffic amount calculating unit calculates the traffic amount per unit time between the wireless LAN apparatuses 100 and 200.

The traffic amount is calculated for (a) each N hours immediately before communication, and (b) for each same use period the day before and an average traffic amount over N days immediately before. In the embodiment, an example of (a) each N hours immediately before communication is employed for description. The AP apparatus managing data 1008 shown in FIG. 11 is stored in the form of a table and consists of, in the example shown, the office number, the traffic amount “N calls, M calls” per unit time of each of the AP apparatuses (wireless LAN apparatuses) 100, 200, and the number of users “0, 1”.

The AP apparatus managing unit 12 collects the office number of the user and the AP apparatus information based on the AP apparatus managing data 1008 managed by the AP apparatus information unit 14 and the input “AP apparatus” and “user information”, retrieves the AP apparatus managing data 1008 having small traffic amount per unit time, and judges whether or not an access from the input “AP apparatus: 100” is appropriate. When the judgment result indicates that the access is appropriate, the AP apparatus managing unit 12 returns AP apparatus OK information together with an authentication code attached thereto to the service servers (web server 20, SIP server 30). However, when the judgment result indicates that the access is not appropriate, the AP apparatus managing unit 12 determines an appropriate AP apparatus (for example, the wireless LAN apparatus 200) by searching, and returns AP apparatus CHANGE information together with an authentication code attached thereto to the service servers (the web server 20, the SIP server 30).

According to the sixth embodiment described above, the route can be set corresponding to the traffic amount per unit time in the wireless LAN apparatuses 100, 200 (see, for example, FIG. 2). As described above, by usually monitoring the traffic amount of the wireless LAN apparatuses, an AP apparatus that the users using the system concentrate on can be identified, and connection can be switched to an AP apparatus having a small traffic amount. Therefore, a wireless LAN apparatus that the users who are using the system concentrate on can be identified and connection can be switched to the AP apparatus having a small traffic for only the users of a specific service. Therefore, leveling of traffic can be facilitated.

A seventh embodiment of the present invention is configured to control the wireless LAN apparatus of an AP for routes on a round-robin basis. In the seventh embodiment, a plurality of AP apparatuses (wireless LAN apparatuses) are arranged in combinations respectively for each service type in the one subnet. For example, in system configuration depicted in FIG. 2, a pair of wireless LAN apparatuses 100 are arranged as wireless LAN apparatuses for VoIP communication. A pair of wireless LAN apparatuses 200 are arranged as wireless LAN apparatuses for HTTP communication. Though the apparatuses are one pair in this example, a plurality of the apparatuses may be arranged in combinations respectively having three or more apparatuses.

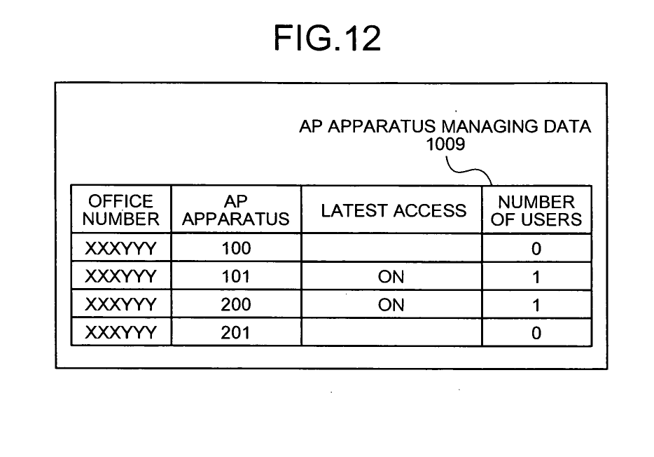

FIG. 12 illustrates a configuration example for managing an organization using a round robin by the AP managing server. The AP apparatus information unit 14 of the AP managing server 10 (see FIG. 2) manages AP apparatus managing data 1009. The AP apparatus managing data 1009 are stored in the form of a table and consists of, in the example shown, the office number, the AP apparatuses (wireless LAN apparatuses) 100, 101, 200, 201, a flag of the latest access “ON=latest access state” to these AP apparatuses, and the number of users “0, 1”. The AP apparatuses 100 and 101 are arranged in a pair as apparatuses for VoIP communication, and the AP apparatuses 200 and 201 are arranged in a pair as apparatuses for HTTP communication.

The AP apparatus managing unit 12 at a constant interval requests re-setting of the latest access flag of the AP apparatus managing data 1009 to the AP apparatus information unit 14. Having received the re-setting request of the latest access flag, the AP apparatus information unit 14 sets a flag ON to the AP apparatus corresponding to the latest access for each office number in the AP apparatus managing data 1009, and sets OFF to other AP apparatuses. In addition, a method of updating the latest access flag on a round-robin basis in groups formed by grouping the AP apparatuses may be contemplated.

According to the example shown in FIG. 12, the latest access flag of the AP apparatus (the wireless LAN apparatus 101) for VoIP communication is ON and, in the next communication, another (next) wireless LAN apparatus 100 in the same group as that of this AP apparatus (wireless LAN apparatus 101) will be the target of the connection of the route with the access terminal 300 on a round-robin basis.

According to the seventh embodiment described above, by selecting on a round-robin basis an AP apparatus (wireless LAN apparatus) in order of accesses of users, the load caused by concentration of accesses for a short time to one AP apparatus can be avoided. Delay of processing between the access terminal and the AP apparatus can also be avoided.

According to the embodiments described above, it is possible to prevent interference by one service to another service, and to execute efficient wireless LAN accesses with a stable communication quality.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A route control system in a wireless local area network (LAN) in which a managing apparatus manages a LAN apparatus to which terminals are wirelessly connected, wherein
the LAN apparatus is arranged in plurality in a single subnet, according to types of services to be provided to the terminals such that a wireless connection route to the terminals is redundant for each of the types, and
the managing apparatus is configured to wirelessly connect the terminal to a LAN apparatus that supports a type of service requested by the terminal.

2. The route control system according to claim 1, wherein the LAN apparatus is provided for each of the types of services.

3. The route control system according to claim 1, wherein
the managing apparatus is configured to manage wireless connection for the LAN apparatus arranged in house or on premises, and
the terminals are configured to access an external server through the managing apparatus.

4. A managing apparatus that controls wireless connection routes between LAN apparatuses and a terminal, the LAN apparatuses arranged in plurality in a single subnet according to types of services to be provided to the terminal such that a wireless connection route to the terminal is redundant for each of the types, the managing apparatus comprising
a route control unit configured to wirelessly connect the terminal to a LAN apparatus that supports a type of service requested by the terminal.

5. The managing apparatus according to claim 4, wherein, the route control unit is configured to notify, via a sever that provides the requested service, the terminal of the LAN apparatus that supports the type of requested service in response to an inquiry from the server, the inquiry issued when the terminal accesses the server.

6. The managing apparatus according to claim 4, wherein, the route control unit is configured to notify the terminal of a LAN apparatus that supports the type of requested service, based on the types of services.

7. The managing apparatus according to claim 4, wherein, the route control unit is configured to notify the terminal of the LAN apparatus that supports the type of requested service in response to an inquiry from the server, the inquiry issued when the terminal accesses the server.

8. The managing apparatus according to claim 4, wherein, the route control unit is configured to notify the terminal of a LAN apparatus that is suitable for a user group to which the terminal belongs, based on a table in which the user group is set in advance.

9. The managing apparatus according to claim 4, wherein, the route control unit is configured to notify the terminal of a LAN apparatus that supports a service requested by the terminal, based on a table in which a type of the service is set in advance.

10. The managing apparatus according to claim 4, wherein, the route control unit is configured to notify the terminal of a suitable LAN apparatus based on a traffic amount of each LAN apparatus.

11. The managing apparatus according to claim 4, wherein, in a configuration in which groups each of which includes a plurality of LAN apparatuses, the groups arranged for respective types of services in a single subnet, the route control unit is configured to notify the terminal of a LAN apparatus determined by a round robin in a group corresponding to a type of service for which connection is established.

12. A terminal that is wirelessly connected to LAN apparatuses that are arranged in plurality in a single subnet according to types of services to be provided to the terminals such that a wireless connection route to the terminals is redundant for each of the types, the terminal comprising:
a service requesting unit configured to transmit information on a type of requesting service to a network side via one of the LAN apparatuses; and
a connection control unit configured to connect the terminal to a LAN apparatus on a connection route indicated in a message received from the LAN apparatus in response to transmission of the information.

13. The terminal according to claim 12, wherein when the message includes a request for handover, the connection control unit switches a LAN apparatus on the connection route to a predetermined LAN apparatus.

14. A method of controlling a route in a wireless LAN with which a connection route between LAN apparatuses and a terminal, the LAN apparatuses arranged in plurality in a single subnet according to types of services to be provided to the terminal such that a wireless connection route to the terminal is redundant for each of the types, the method comprising:
transmitting information on a type of a service requested by the terminal to a network side via one of the LAN apparatuses;
notifying the terminal of a LAN apparatus that supports the type of the service requested by the terminal; and
connecting the terminal to the LAN apparatus notified.
